(19) United States
(12) Patent Application Publication
(10) Pub. No.: US 2013/0250715 A1
(43) Pub. Date: Sep. 26, 2013

(54) METHOD AND SYSTEM FOR ADJUSTING FOOD AND BAKING FORMULAS

(71) Applicant: Robert White, Brightwaters, NY (US)

(72) Inventor: Robert White, Brightwaters, NY (US)

(21) Appl. No.: 13/429,750

(22) Filed: Mar. 26, 2012

(51) Int. Cl. G05D 11/02

(52) U.S. Cl. 366/152.1

(57) ABSTRACT

Method and system for automatically adjusting a formula for producing a food product from a plurality of ingredients includes at least one sensor that measures a property of an ingredient used in the formula or an ambient condition around equipment producing the food product. A processor determines an adjusted quantity of at least one ingredient used in the formula based on the measurement by the sensor(s) and a quantity of that ingredient set forth in the formula. The adjusted quantity of this ingredient is mixed together with remaining ingredients in the formula. The sensor may be a sensor that measures temperature of the at least one ingredient, a sensor that measures moisture content of the at least one ingredient, a sensor that measures ambient temperature around the equipment, or a sensor that measures relative humidity around the equipment.

### FIELD OF THE INVENTION

The present invention relates to methods for adjusting food formulas, and particularly formulas for producing bakery products, based on differences between current food preparation and baking conditions and conditions under which the formulas were developed, with the objective being to consistently produce quality food products having desired characteristics.

The present invention also relates to systems or arrangements for obtaining information about ingredients used in food formulas, and particularly formulas for bakery products, and adjusting the quantity of the ingredients based on differences between current food preparation and baking conditions, and conditions under which the formulas were developed, with the objective being to consistently produce quality food products having desired characteristics.

### BACKGROUND OF THE INVENTION

Formulas or recipes for food products typically include specifications which relate to the quantity of ingredients used to produce the food products. When such specifications are followed however, the resultant food products are not always the same because variations in the conditions under which the food products are manufactured and variations in the properties of the ingredients affect the production of the food products. The specifications associated with a recipe or formula are therefore often adjusted or varied to compensate for the manufacturing conditions and/or the conditions of the ingredients.

The cause and effect of variations in the specifications of food product formulas relating to, for example, moisture content analysis, temperature analysis, pH analysis and specific gravity measurement, in particular for the manufacture of dough-based food products and flour-based food products, are difficult to quantify. As a result, during production of dough and flour-based food products, there are usually batches of the products that not edible or saleable.

It is not believed that anyone has, to date, devised an automatic method or system to adjust a formula or recipe for making a food product, in particular a dough or flour-based food product, by measuring deviations from setpoints or conditions under which the formula was determined and then subsequently adjusting the setpoints based on, for example, ambient conditions when the products are being manufactured.

It would therefore be highly desirable to provide such an automatic method and system in order to eliminate bad batches of food products (waste) when following formulas or recipes to make food products. Such an automatic method and system would also enable manufacturers and their personnel to avoid having to doctor recipes by guesswork, which can produce poor quality food and bakery products.

### SUMMARY OF THE INVENTION

A method for automatically adjusting a formula for producing a food product from a plurality of ingredients in accordance with the invention includes providing at least one sensor, measuring by means of each sensor, a property of an ingredient used in the formula or an ambient condition around equipment producing the food product, determining by a processor, an adjusted quantity of at least one ingredient used in the formula based on the measurement by the sensor(s) and a quantity of that ingredient set forth in the formula, and mixing the adjusted quantity of the at least one ingredient together with remaining ingredients in the formula. The sensor may be a sensor that measures temperature of the at least one ingredient, a sensor that measures moisture content of the at least one ingredient, a sensor that measures ambient temperature around the equipment, or a sensor that measures relative humidity around the equipment.

A related system for automatically adjusting a formula for producing a food product from a plurality of ingredients includes at least one sensor that measures a property of at least one of the ingredients used in the formula or an ambient condition around equipment producing the food product, and a processor coupled to the sensor(s) and that determines an adjusted quantity of at least one ingredient used in the formula based on the measurement of the sensor(s) and a quantity of that ingredient set forth in the formula. The sensor may be as described for the method.

### BRIEF DESCRIPTION OF THE DRAWINGS

The invention may best be understood by reference to the following detailed description of an illustrative embodiment when read in conjunction with the accompanying drawings, wherein:

FIG. 1 is a flow chart of a method in accordance with the invention; and

FIG. 2 is a schematic of a system or an arrangement for implementing the method in accordance with the invention.

### DETAILED DESCRIPTION OF THE INVENTION

A method in accordance with the invention is particularly applicable to formulas or recipes for dough-based products and flour-base products and will often be described with reference thereto, namely, with reference to crackers and biscuits. However, the invention is not limited to such products and may be generally used to automatically correct any formula in which multiple ingredients are mixed and which ingredients or mixture thereof is/are affected by properties, characteristics or conditions of the ingredients or mixture thereof or of the ambient or surrounding environment, including but not limited to, moisture content of an ingredient, temperature of a liquid ingredient, moisture content of the mixture, and ambient or environmental manufacturing conditions, such as temperature and humidity.

Generally, the method entails measuring one or more of the properties, characteristics and/or conditions of one or more of the ingredients used in the formula or a mixture thereof and/or environmental conditions of the production process, and calculating adjustments to the formula by means of a microprocessor or computer program based on these measurements. The adjustments to the recipe or formula may result in a higher or lower amount of a specific ingredient, e.g., water, being used in the formula. By means of such adjustments, the resultant product should more closely correspond to the product intended to be produced by the recipe, e.g., exhibit the same taste, consistency, form, etc., as the product when made by the unadjusted formula under the same conditions as the unadjusted formula was developed.

As mentioned above, use of the method will be explained with reference to manufacturing a biscuit or cracker, as examples of dough-based and flour-based products.

In the biscuit and cracker manufacturing field, a bulk moisture content is changed from typically about 18% in the dough mix, to typically about 2% in the final product. This substantial change in moisture content can result in mechanical stress within the biscuit. It is recognized that there is a direct relationship between the moisture content and the subsequent damage (checking) of the biscuits that may occur sometime after packaging. There is also a relationship between moisture and flavor of the biscuits, either of flavors caused by a stale product or burnt flavors caused by over-baking.

Variances in water supply temperature or the effectiveness of a water chiller, used to process the water used when manufacturing the cracker or biscuit, can produce “out-of-specification” doughs that will result in poor crackers and biscuits or outright waste of resulting crackers and biscuits.

Accordingly, it is a problem that variances in dry ingredient moisture content from the specification in the recipe cause inconsistent results and bad batches. Further, variances in the ingredient temperatures and variances in the ambient manufacturing conditions, such as temperature and humidity, cause inconsistent results. Moreover, out-of-specification product moisture content has adverse affects on the finished product. Thus, the moisture content of the ingredients should be determined as a first step in analyzing the flour-based product for the purpose of assessing whether any adjustments in the formula are needed.

In a conventional manner, to determine moisture content of a flour-based product, such as a cracker or biscuit, a small sample of flour or ground wheat (for example, about 2 to about 3 grams) is weighed and placed in a moisture dish. The sample is heated at, for example, about 130 degrees Celsius in an air oven for about 1 hour. The sample is cooled to room temperature and the residue is weighed.

Moisture content is determined by comparing the weight of the sample before and after heating in the air oven. The amount of weight loss is the moisture content. Moisture content results are expressed as a percentage, e.g., wheat moisture content is about 12 percent.

When preparing to implement a recipe or formula in accordance with the automatic correction of the specifications thereof in the method and system of the invention, determining moisture content is an essential first step in analyzing the flour quality since this data is used for other tests and calculations. This is obviously necessary only when flour, or wheat used to make flour, is one of the ingredients in the recipe. Flour millers adjust the moisture in wheat to a standard level before milling. Moisture content of about 14 percent is commonly used as a conversion factor for other tests in which the results are affected by moisture content. This method is time consuming and is not tied to the automatic batching process.

The invention can use the above described technique to measure moisture content or any other technique known to those skilled in the art.

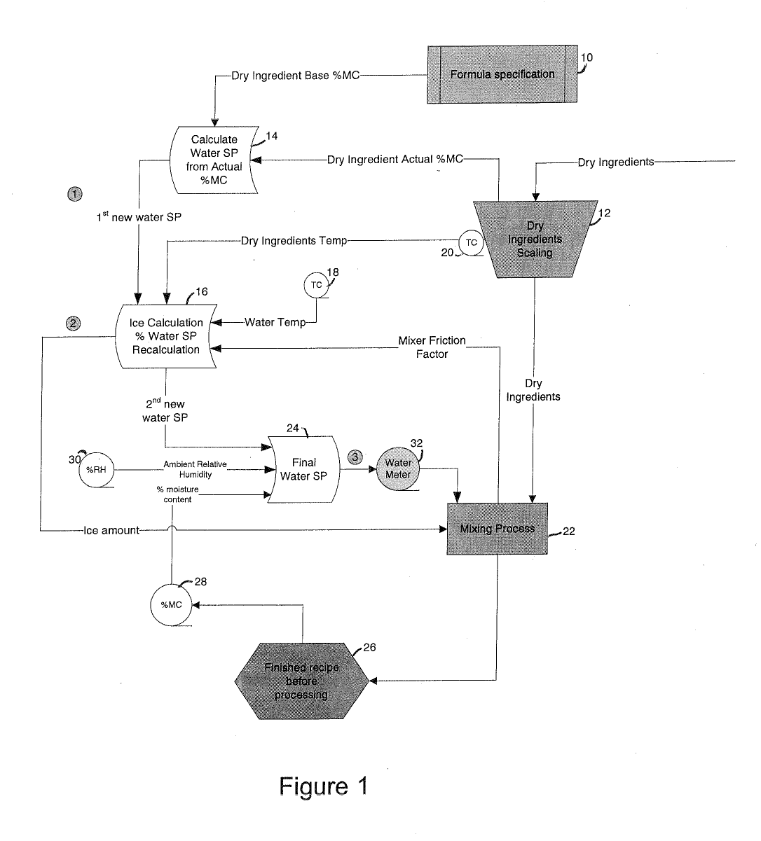

Referring now to FIG. 1, the method in accordance with the invention automatically measures through electronic probes, sensors or sensor systems (hereinafter referred to simply as “sensors”), parameters relating to the specifications in the formula, including, for example, temperatures of one or more of the ingredients, moisture content of one or more of the ingredients and humidity of the ambient atmosphere, and automatically calculates and adjusts/corrects the ingredient setpoints in the automated batching system before the food product production process starts. Optimally, the method will eliminating out-of-specification batches, i.e., batches that either cannot be used, or are used as scrap thereby diluting batch quality, and batches that require manual doctoring.

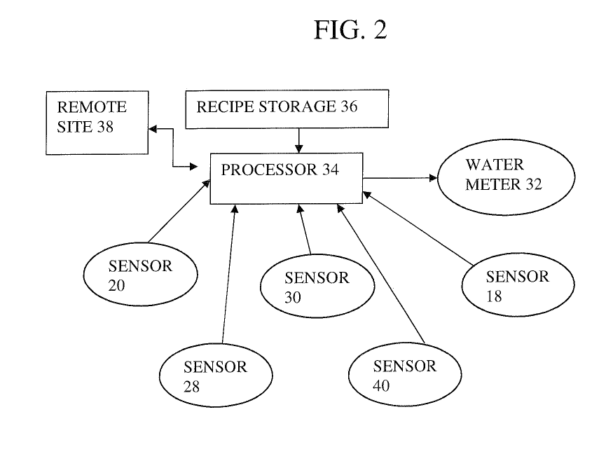

The formula specifications 10 are provided to the processor, e.g., from a memory component that stores the specifications on computer-readable media. Alternatively, the specifications may be provided by means of a communications network. This is depicted in FIG. 2, wherein the processor 34 is connected to the formula storage component 36, e.g., a formula or recipe database, and also communicates with a remote site 38 to obtain therefrom formulas. This communication is illustrated by means of an arrow and may take place in a wired or wireless manner and using any known telecommunications techniques and frequencies.

One or more of the dry ingredients used in the formula are scaled at 12 by conventional scaling equipment known to those skilled in the food and baking fields. A dry ingredient actual moisture content is determined in a manner known to those skilled in the art and provided to a processor. This may be achieved by means of a sensor or by obtaining data about the ingredient from the producer or provider thereof.

The processor conducts a first processing or calculation stage, 14, in which it subtracts the Actual (Act) measured Moisture Content (MC), ACT MC %, from the Standard (STD) moisture content, STD MC %, to obtain a differential (Diff) moisture content, MC Diff %, as follows:

$$\frac{\begin{matrix}STD MC \% - \\ Act MC \%\end{matrix}}{MC Diff}$$

The processor then multiplies the moisture content difference (MC Diff %) by the amount of dry ingredients in the recipe (i.e., Flour) as follows:

$$\frac{\begin{matrix}MC Diff \% \times \\ lbs Flour\end{matrix}}{Lbs of water to add or subtract}$$

to obtain the amount of water to add or subtract from the water setpoint in the formula (the quantity of water specified in the formula), assuming water is an ingredient in the formula. This calculation and the following related calculations are set forth with respect to water as an ingredient but are applicable to other ingredients in the formula.

The adjusted amount of water constitutes a new water setpoint, i.e., “the 1^{st} new water SP” in FIG. 1, as follows:

$$\frac{\begin{matrix}setpoint of water amount \pm \\ lb of water to add or subtract\end{matrix}}{{1}^{st} new water set point}$$

As an additional calculation or processing step, 16, the processor calculates a second new water setpoint, i.e., 2^{nd} new water setpoint, by subtracting a calculated ice set point from the 1^{st} new water setpoint, as follows:

$$\frac{\begin{matrix}{1}^{st } new water setpoint \pm \\ final recalculated ice setpoint\end{matrix}}{{2}^{nd} new water set point}$$

The calculated ice setpoint is calculated by the processor analyzing the current water supply temperature, the ambient temperature, the dry ingredient temperature (i.e., flour), and/or the mixer coefficient of friction on the product.

The current water supply temperature is obtained by a temperature sensor 18 associated with the water supply in a manner known to those skilled in the art. The ambient temperature is obtained by a temperature sensor in a manner known to those skilled in the art. The dry ingredient temperature, i.e., the temperature of the flour, is also obtained by a temperature sensor 20 in a manner known to those skilled in the art. Temperature sensor 20 may also represent a moisture content sensor that measures moisture content of the dry ingredients, whether during the scaling process or otherwise.

Finally, the mixer coefficient of friction of the product is obtained by a friction sensor or system in a manner known to those skilled in the art. The mixer coefficient may be expressed as mixer friction factor as illustrated by the arrow from a mixing process 22. Mixing process 22 represents mixing equipment that mixes some or all of the ingredients in the formula together, including any ingredients whose quantity has been adjusted by the application of the formula.

As a third calculating or processing step, 24, the processor determines the amount of water to be used in the recipe, the final water setpoint or Final Water SP in FIG. 1, by adjusting the 2^{nd} new water setpoint, based on a reading of the moisture content of a previously manufactured product 26 obtained via a moisture content sensor 28. The sensor 28 is operative on the product before final processing on the production equipment. Also, the processor obtains from a humidity sensor 30, the ambient relative humidity.

With these inputs, the processor calculate the difference in the actual setpoints versus the corresponding formula-specified setpoints, e.g., moisture content of an ingredient, and adjust the next water set point accordingly.

FIG. 2 is a schematic showing the components of the system in accordance with the invention which implement the method described above. The processor 34 is coupled to the sensors 18, 20, 28 and 30, as well as to an additional sensor 38 which represents a sensor that determines whatever additional measureable condition for an ingredient or the ambient atmosphere is needed for the formula, for example, the pH of an ingredient. This coupling may be a wired or wireless coupling, as known to those skilled in the art. The processor 34 is also coupled to the formula storage component 36 and/or the remote site 38 as mentioned above. These components provide input to the processor 34, which performs the calculation stages described above and outputs a control command to the water meter 32.

Processor 34 may be any processing unit, microprocessor, controller, microcontroller, etc. known to those skilled in the art. Conventional attachments and control or user interfaces for the processor 34 are also contemplated, e.g., a keyboard and mouse.

Instead of or in addition to the water meter 32, the processor 34 can also generate and output other control commands to other ingredient flow-regulating components that regulate the flow of the components into the mixing equipment. These control commands would be based on one or more of the inputs provided the processor 34, and calculations performed by the processor 34 to adjust the quantity of the ingredients based on the input(s) and the quantity set forth in the formula.

The foregoing method and system, in any of their various forms, overcomes a problem of measuring ingredient attributes and environmental conditions and then manually calculating and making adjustments to a recipe or formula specifications of a food or bakery product to compensate for variations and/or deviations to the specifications. This is necessary because the conditions under which the specifications are determined is often different than the conditions when the recipe is being followed to make food and bakery products.

Further, the foregoing method and system, in any of their various forms, automatically corrects food and baking formulas based on variances in the formula specifications, and specifically, dry ingredient moisture content (such as flour), liquid temperatures and finished product/dough moisture content and environmental conditions such as temperature and humidity, before the time of mixing of ingredients and again before processing the mixed product.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

I claim:

1. A method for automatically adjusting a formula for producing a food product from a plurality of ingredients, comprising:
providing at least one sensor;
measuring by means of the at least one sensor, a property of at least one of the ingredients used in the formula or an ambient condition around equipment producing the food product;
determining by a processor, an adjusted quantity of at least one of the ingredients used in the formula based on the measurement of the at least one sensor and a quantity of the at least one ingredient set forth in the formula; and
mixing the adjusted quantity of the at least one ingredient together with remaining ingredients in the formula.

2. The method of claim 1, wherein the at least one sensor measures temperature of the at least one ingredient.

3. The method of claim 1, wherein the at least one sensor measures moisture content of the at least one ingredient.

4. The method of claim 1, wherein the at least one sensor measures ambient temperature around the equipment.

5. The method of claim 1, wherein the at least one sensor measures relative humidity around the equipment.

6. The method of claim 1, wherein the step of determining the adjusted quantity of the at least one ingredient comprises determining the adjusted quantity of the at least one ingredient based on moisture content of a previously produced food product.

7. The method of claim 1, wherein an ingredient in the formula and the step of determining the adjusted quantity of the least one ingredient comprises determining a first adjusted setpoint used to determine a quantity of the at least one ingredient to use in the formula based on moisture content of another ingredient in the formula.

8. The method of claim 7, wherein the at least one sensor comprises a first temperature sensor that measures temperature of the at least one ingredient, and a second temperature sensor that measures temperature of the another ingredient which is a dry ingredient.

9. The method of claim 8, further comprising obtaining a mixer friction coefficient relating to the mixing of the ingredients, the step of determining the adjusted quantity of the at least one ingredient further comprises determining a second adjusted setpoint based on the temperature measured by the first temperature sensor, the temperature measured by the second temperature sensor, the mixer friction coefficient and the first adjusted setpoint.

10. The method of claim 9, wherein the at least one sensor further comprises a humidity sensor that measures humidity around the equipment and a moisture content sensor that measures moisture content of a previously produced food product.

11. The method of claim 10, wherein the step of determining the adjusted quantity of the at least one ingredient further comprises determining a final adjusted setpoint based on the humidity measured by the humidity sensor, the moisture content measured by the moisture content sensor and the second adjusted setpoint.

12. A system for automatically adjusting a formula for producing a food product from a plurality of ingredients, comprising:
at least one sensor that measures a property of at least one of the ingredients used in the formula or an ambient condition around equipment producing the food product; and
a processor coupled to said at least one sensor and that determines an adjusted quantity of at least one of the ingredients used in the formula based on the measurement of said at least one sensor and a quantity of the at least one ingredient set forth in the formula,
whereby the adjusted quantity of the at least one ingredient is mixed together with remaining ingredients in the formula.

13. The system of claim 12, wherein said at least one sensor measures temperature of the at least one ingredient.

14. The system of claim 12, wherein said at least one sensor measures moisture content of the at least one ingredient.

15. The system of claim 12, wherein said at least one sensor measures ambient temperature around the equipment.

16. The system of claim 12, wherein said at least one sensor measures relative humidity around the equipment.

17. The system of claim 12, wherein said processor determining the adjusted quantity of the at least one ingredient by determining a first adjusted setpoint used to determine a quantity of the at least one ingredient to use in the formula based on moisture content of another ingredient in the formula which is a dry ingredient.

18. The system of claim 17, wherein said at least one sensor comprises a first temperature sensor that measures temperature of the at least one ingredient, and a second temperature sensor that measures temperature of the dry ingredient.

19. The system of claim 18, wherein said processor determines the adjusted quantity of the at least one ingredient by determining a second adjusted setpoint based on the temperature measured by said first temperature sensor, the temperature measured by said second temperature sensor, a mixer friction coefficient relating to the mixing of the ingredients, and the first adjusted setpoint.

20. The system of claim 19, wherein said at least one sensor further comprises a humidity sensor that measures humidity around the equipment and a moisture content sensor that measures moisture content of a previously produced food product, said processor determining the adjusted quantity of the at least one ingredient by determining a final adjusted setpoint based on the humidity measured by said humidity sensor, the moisture content measured by said moisture content sensor and the second adjusted setpoint.
